(19) United States
(12) Patent Application Publication
(10) Pub. No.: US 2023/0083662 A1
(43) Pub. Date: Mar. 16, 2023

(54) HEATER UNIT

(71) Applicant: Zoppas Industries de Mexico S.A., de C.V., San Luis Potosí (MX)

(72) Inventors: Maurizio Francesco Pasqual, San Luis Potosi (MX); Jose Jesus Reyes Soto, San Luis Potosí (MX); Alfredo Cuevas Morales, San Luis Potosí (MX); Pierpaolo Campeol, San Luis Potosí (MX)

(21) Appl. No.: 17/850,710

(22) Filed: Jun. 27, 2022

Related U.S. Application Data
(63) Continuation of application No. 29/694,309, filed on Jun. 10, 2019, now Pat. No. D955815.

(51) Int. Cl. H05B 1/02

(52) U.S. Cl. CPC H05B 1/0266

(57) ABSTRACT

We have invented a new, original, and ornamental design for a heater unit. The following is a specification of the heater unit, reference being had to the accompanying drawings, which form a part hereof.

### DESCRIPTION OF THE DRAWINGS

FIG. 1 is a top, front, and left side perspective view of a heater unit of our design;

FIG. 2 is a bottom, front, and right side perspective view thereof;

FIG. 3 is a top view thereof;

FIG. 4 is a bottom view thereof;

FIG. 5 is a right side view thereof;

FIG. 6 is a left side view thereof;

FIG. 7 is a rear view thereof; and

FIG. 8 is a front view thereof.

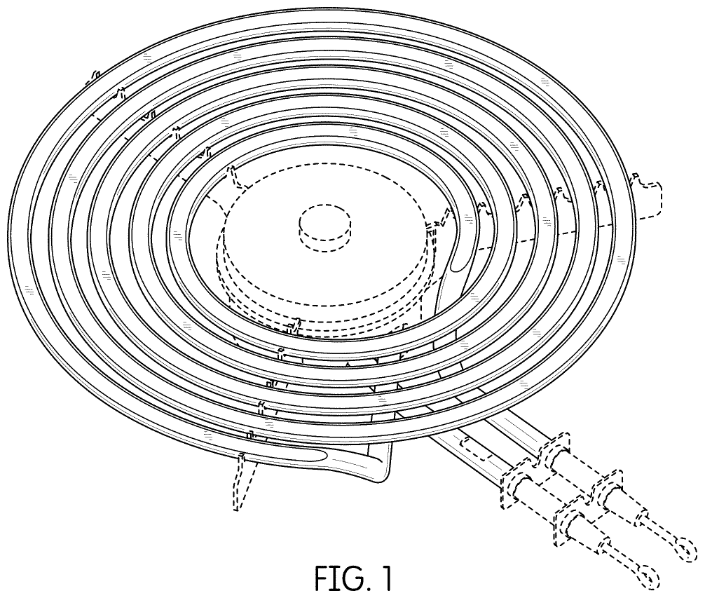

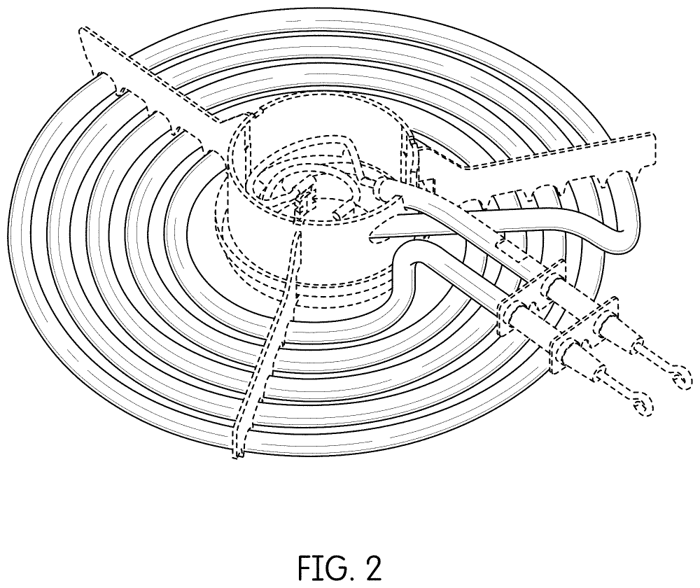

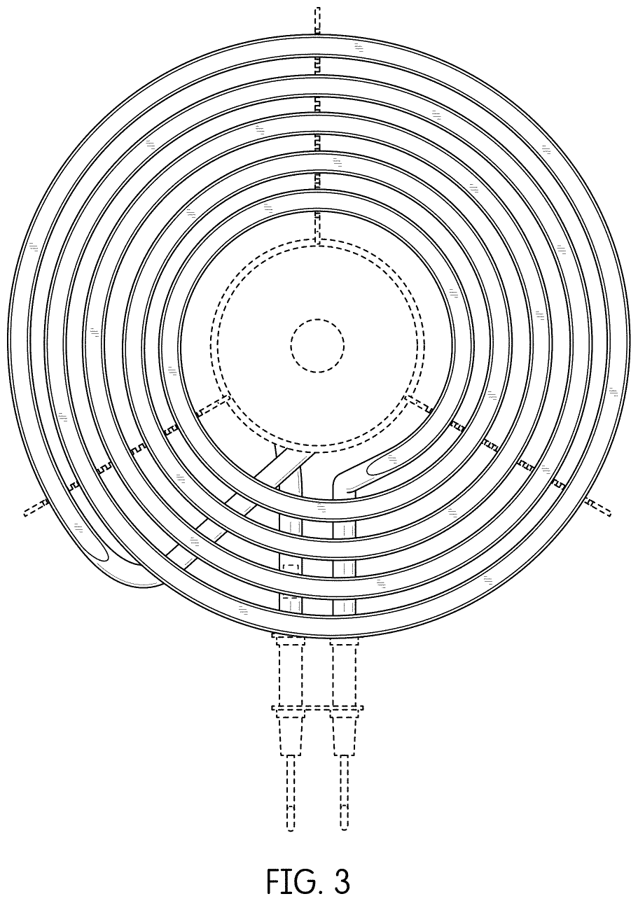

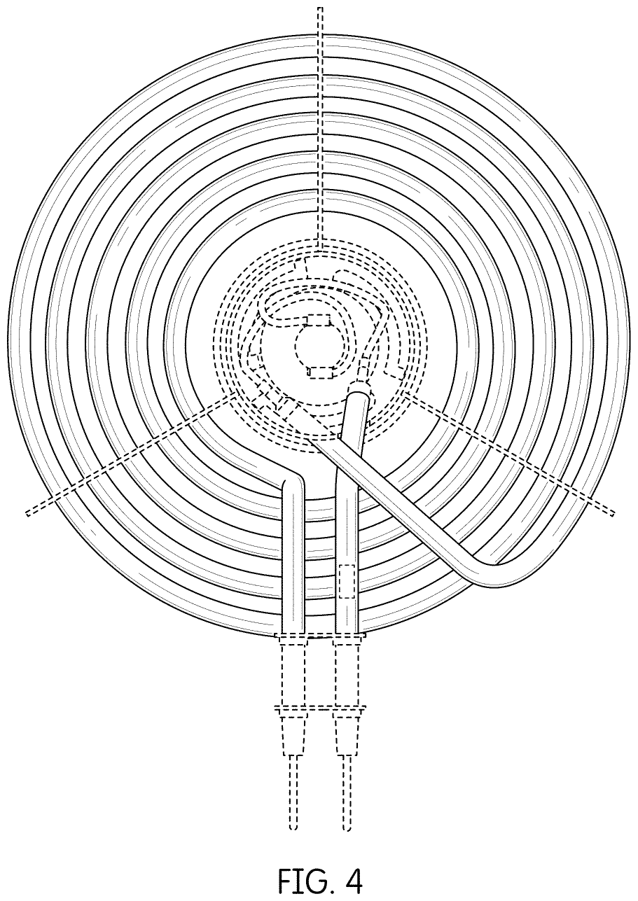

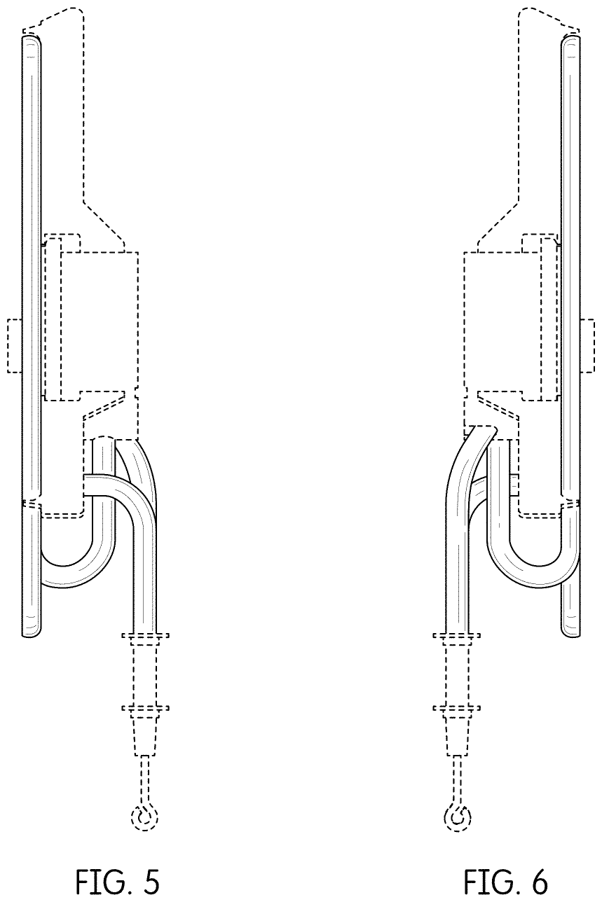

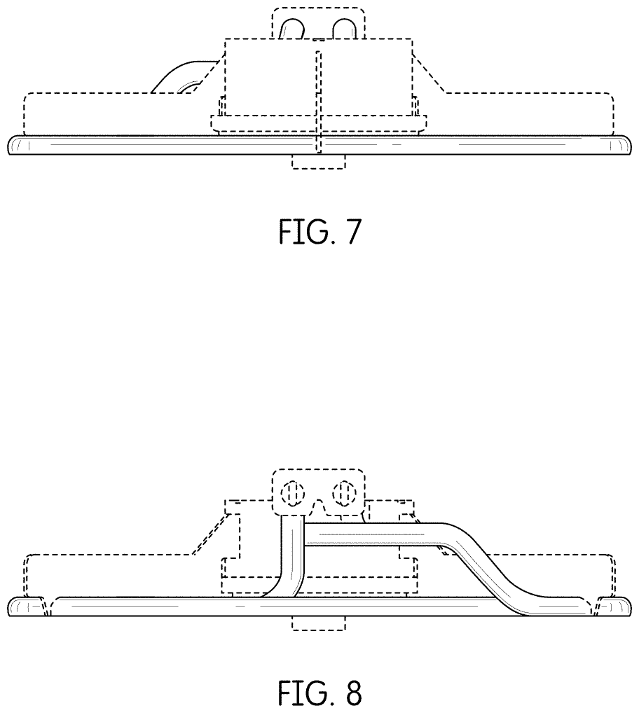

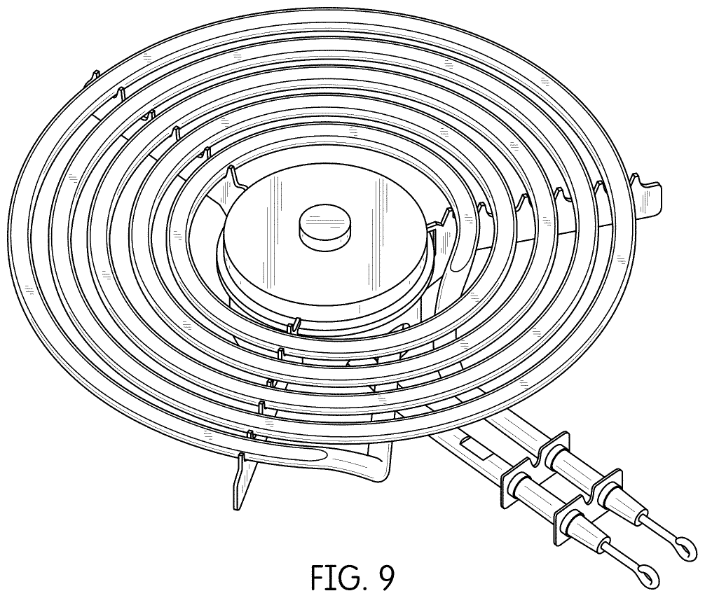

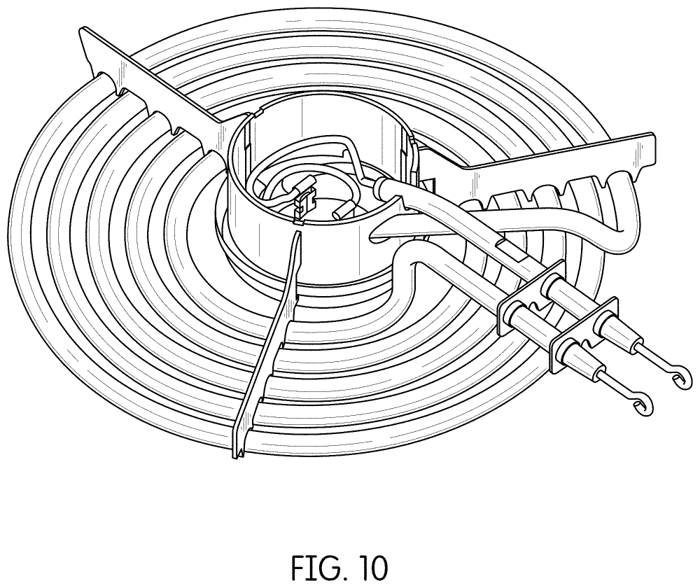

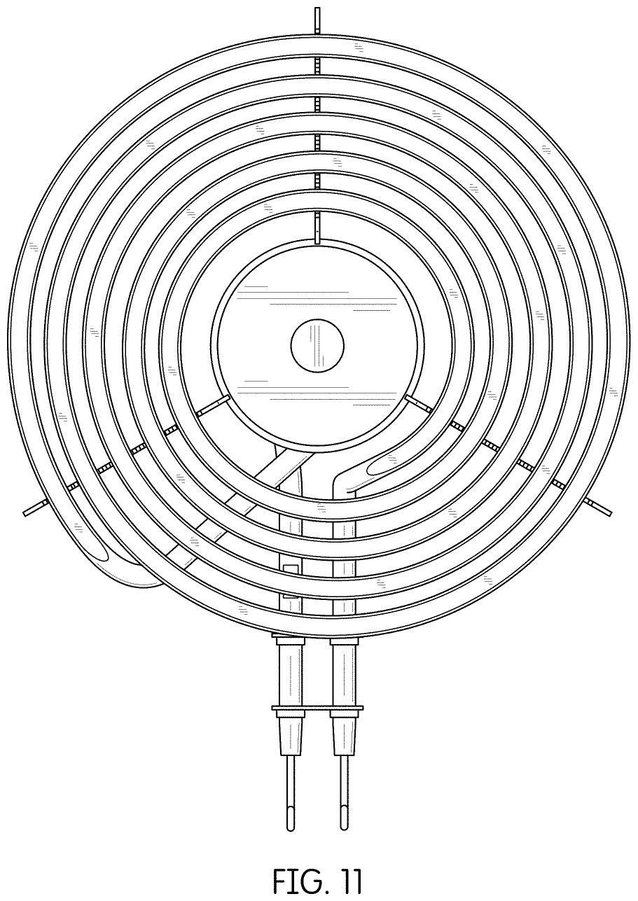

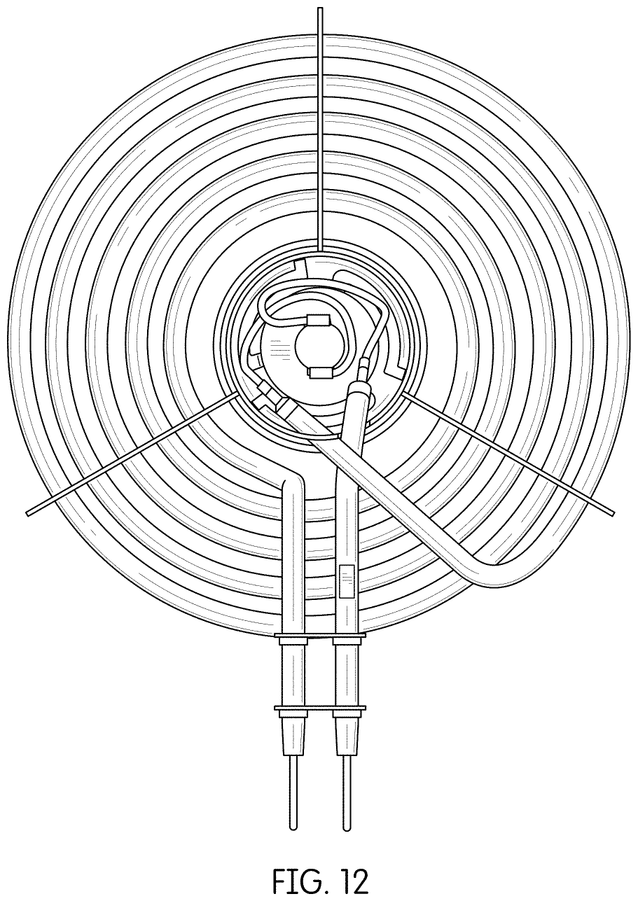

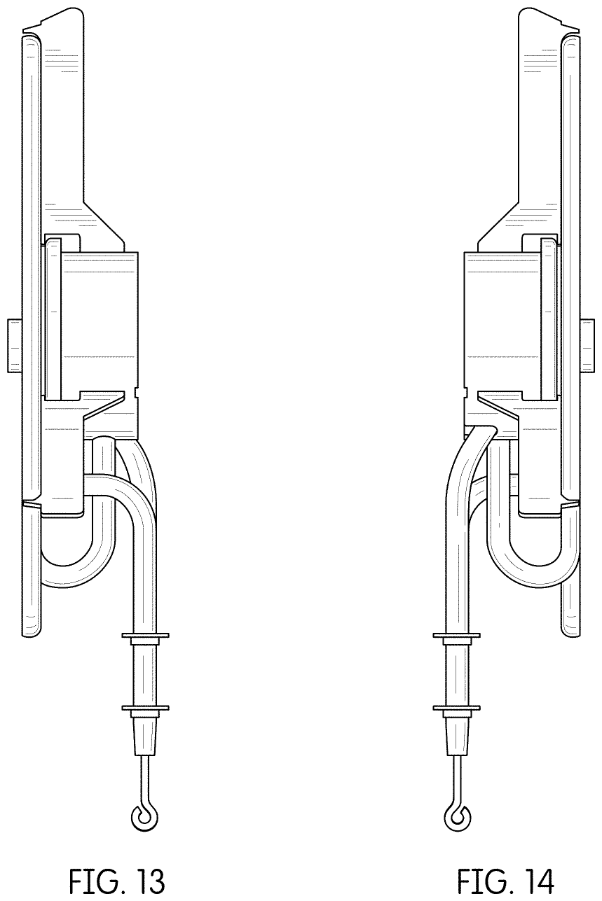

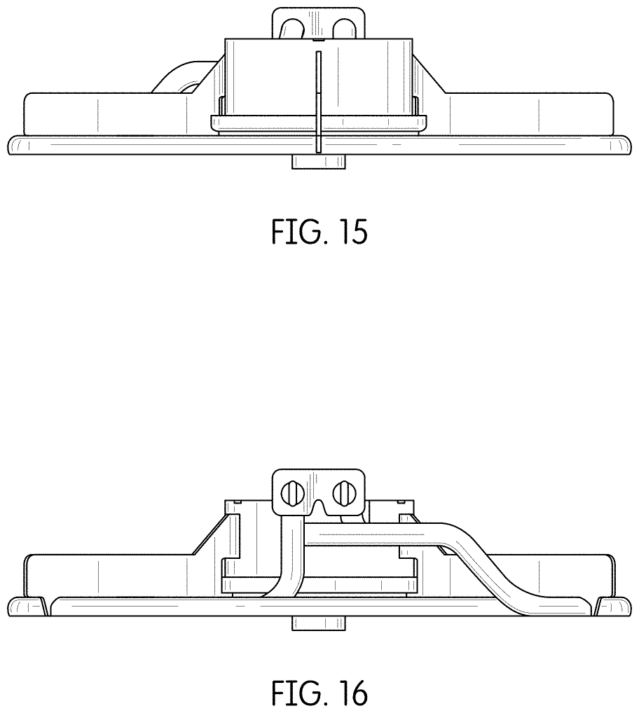

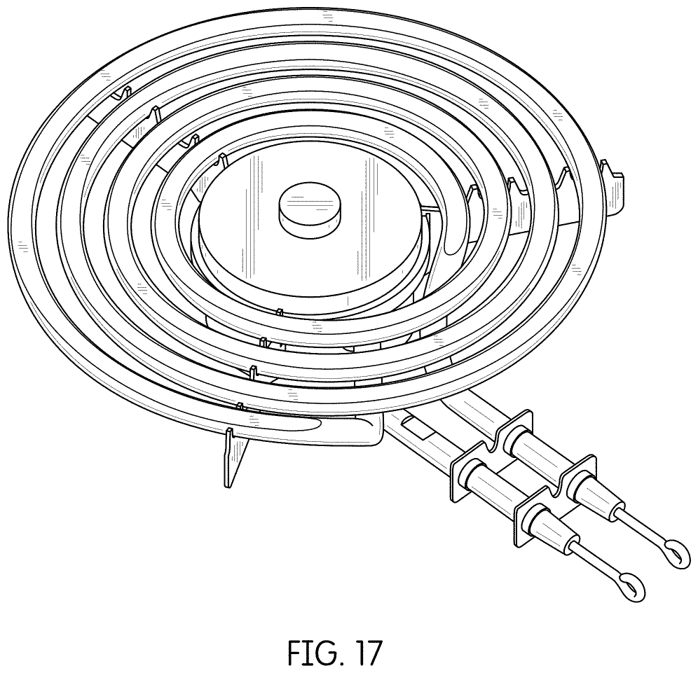

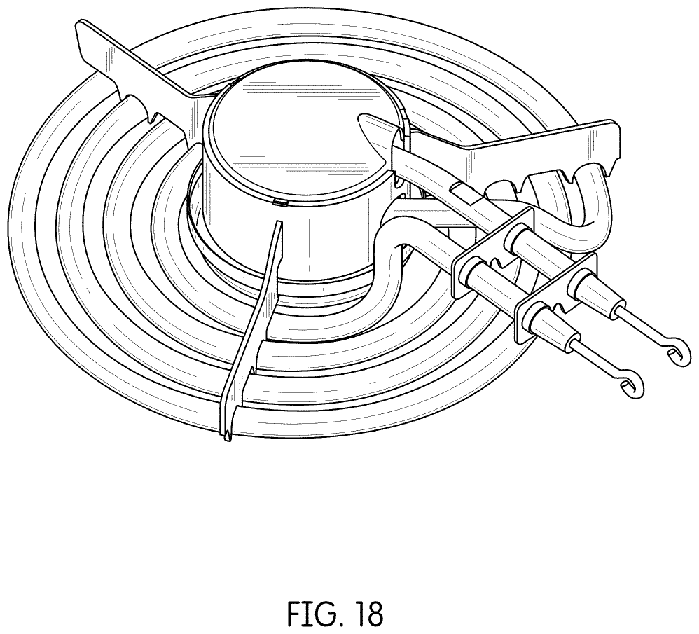

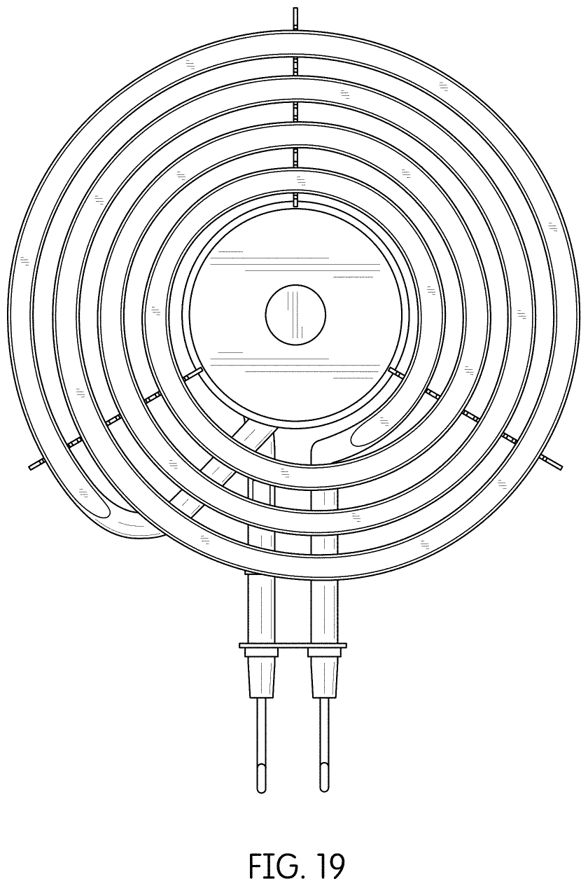

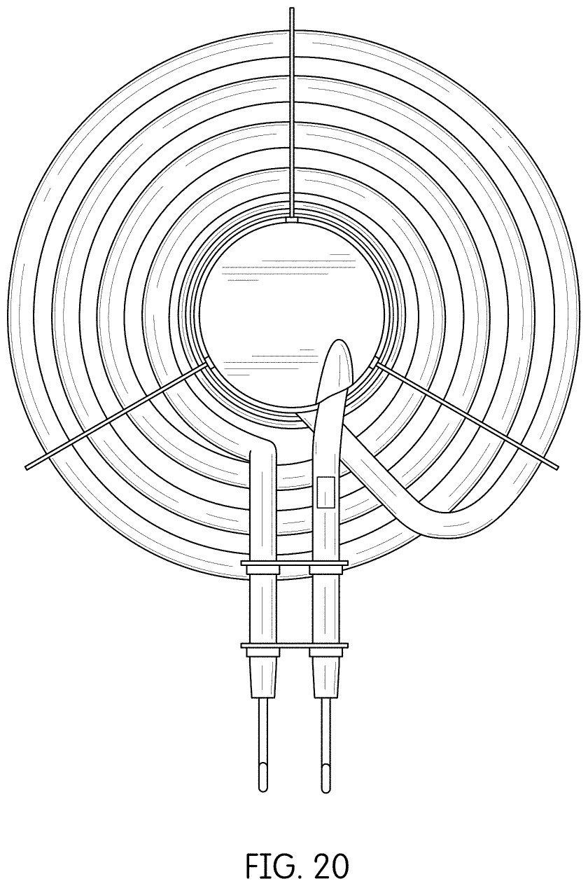

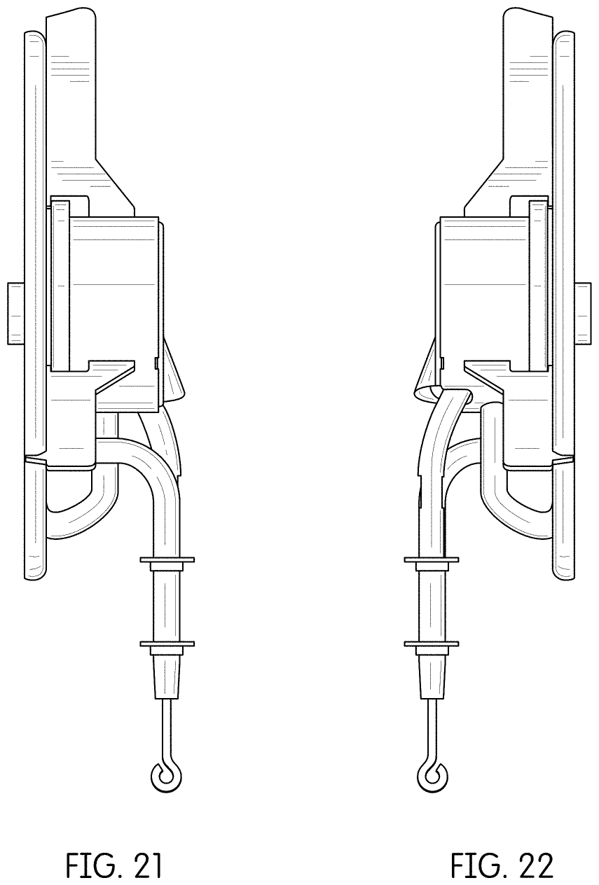

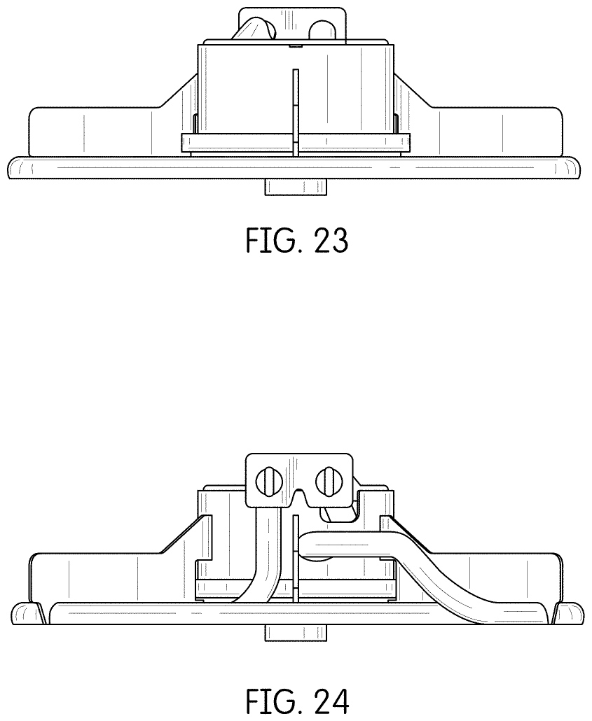

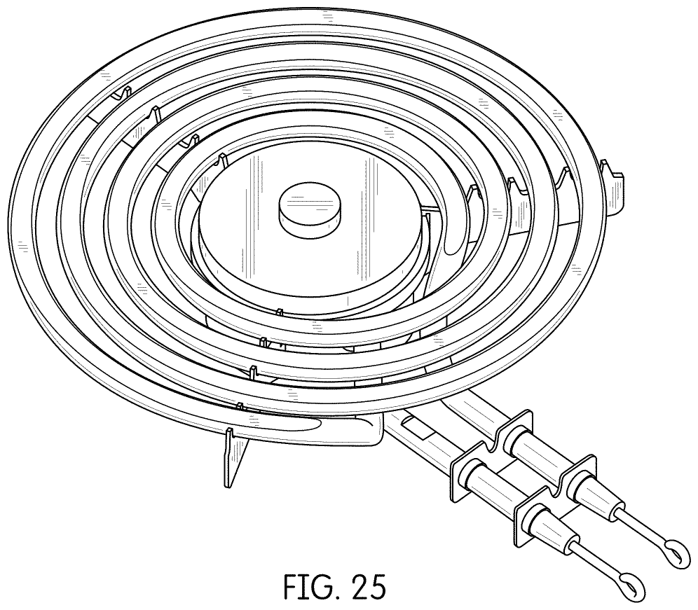

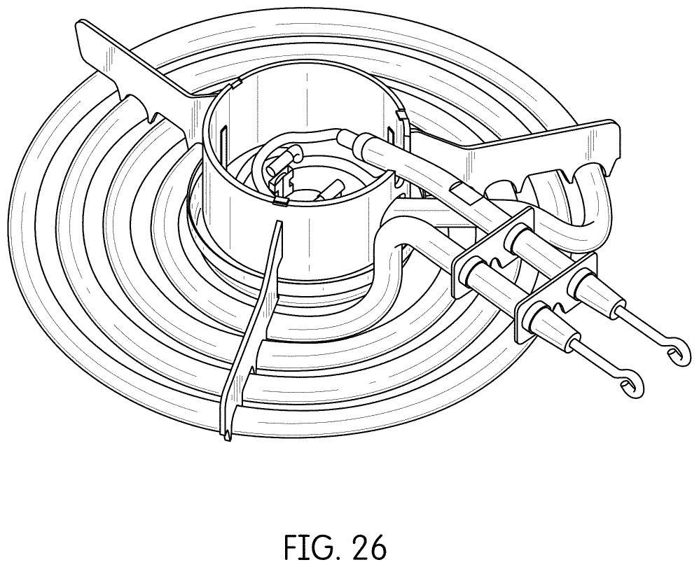

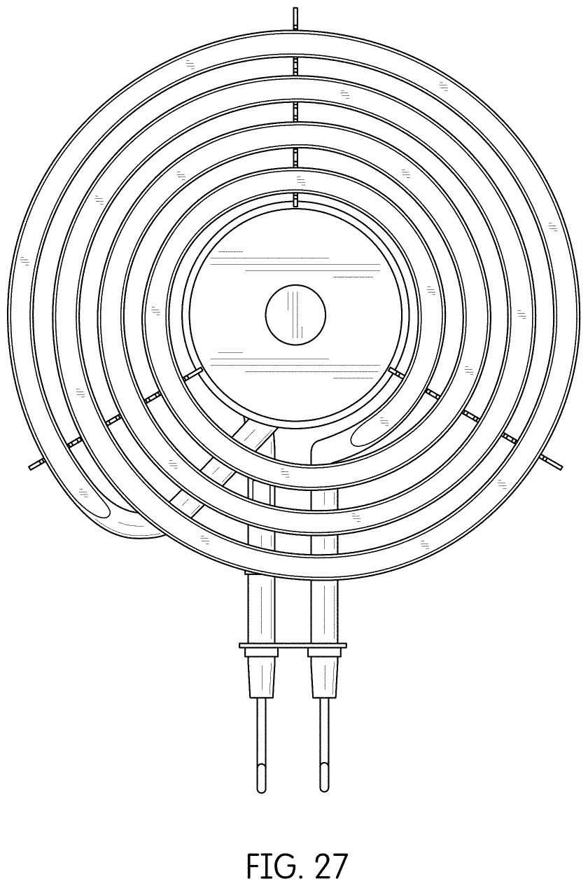

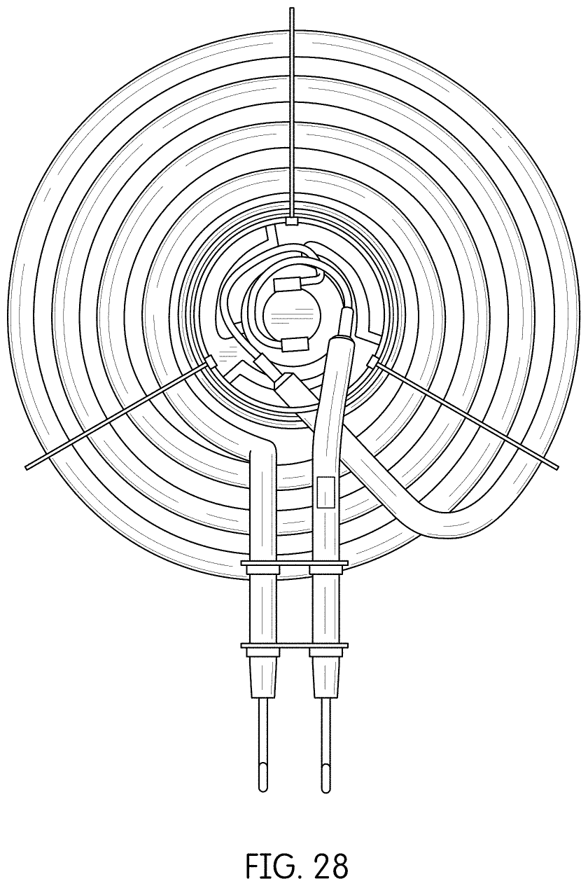

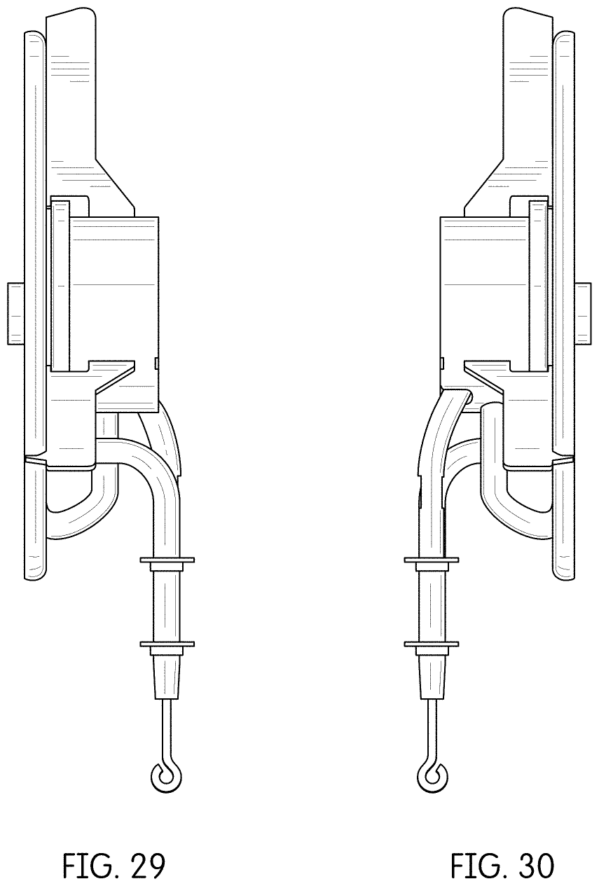

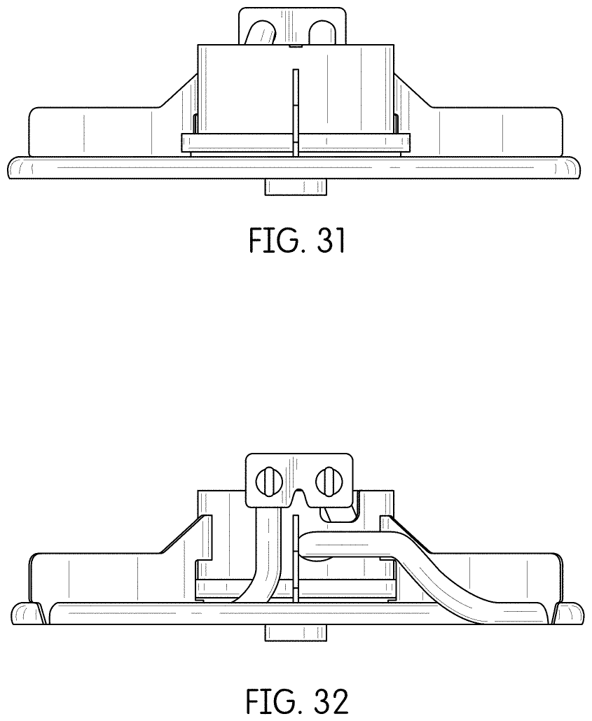

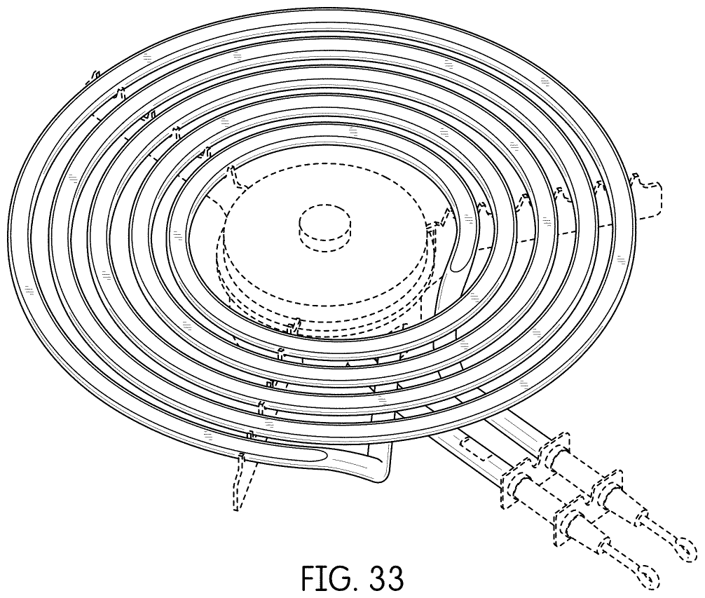

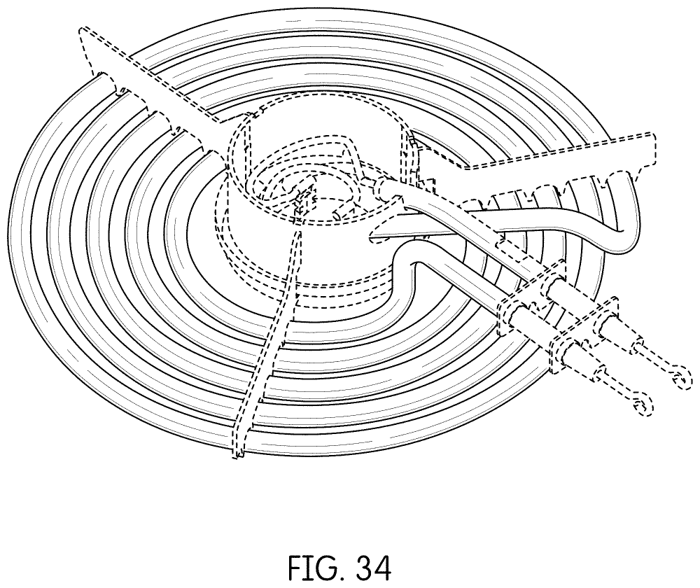

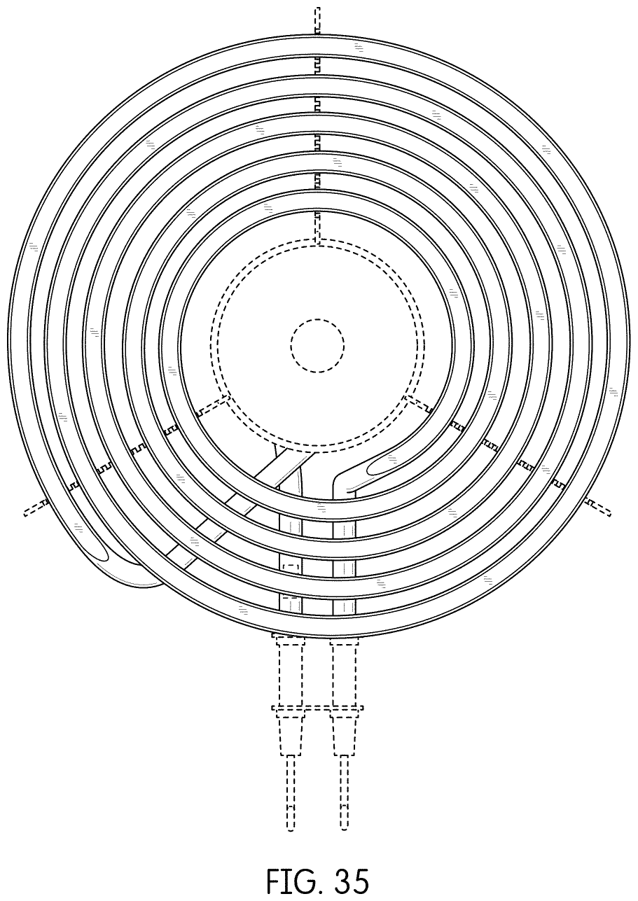

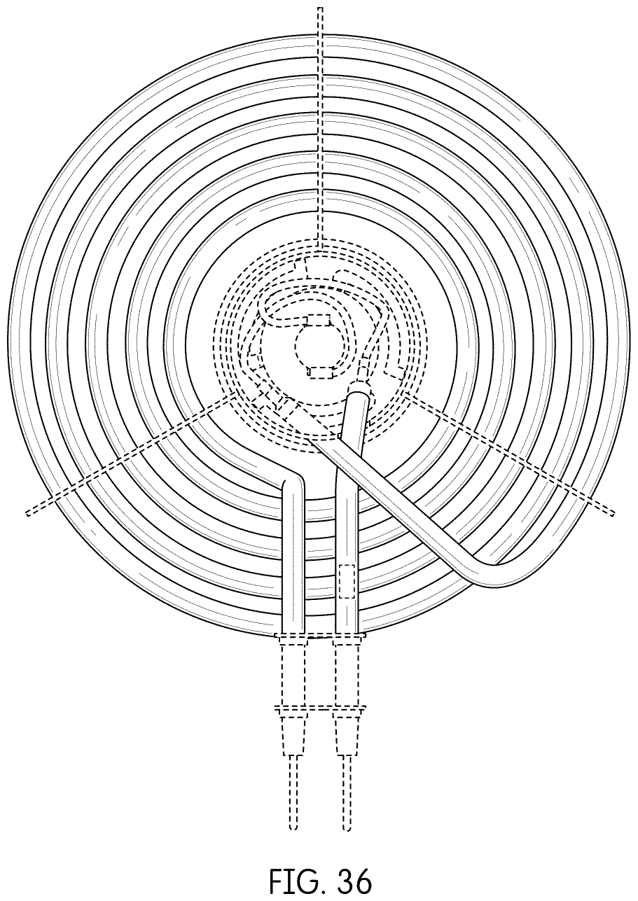

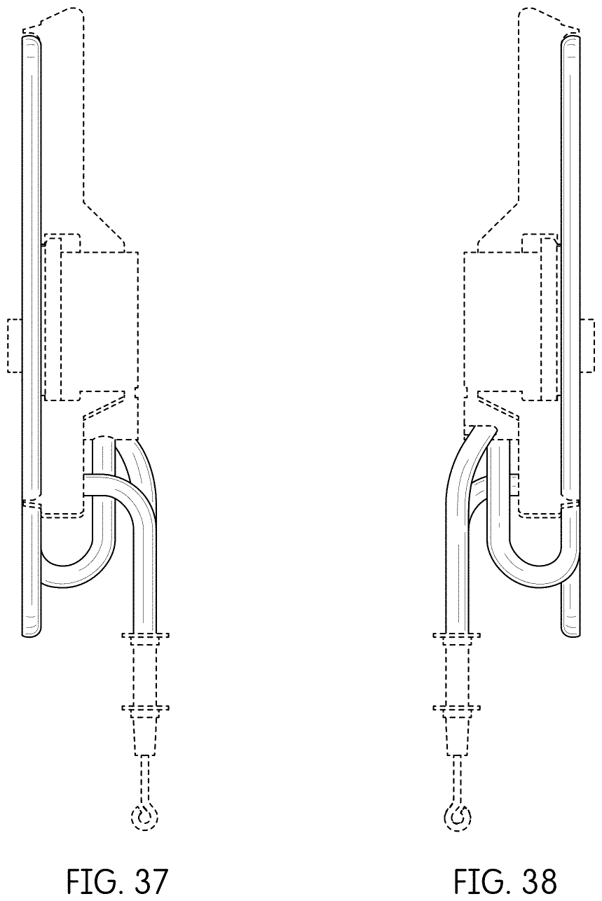

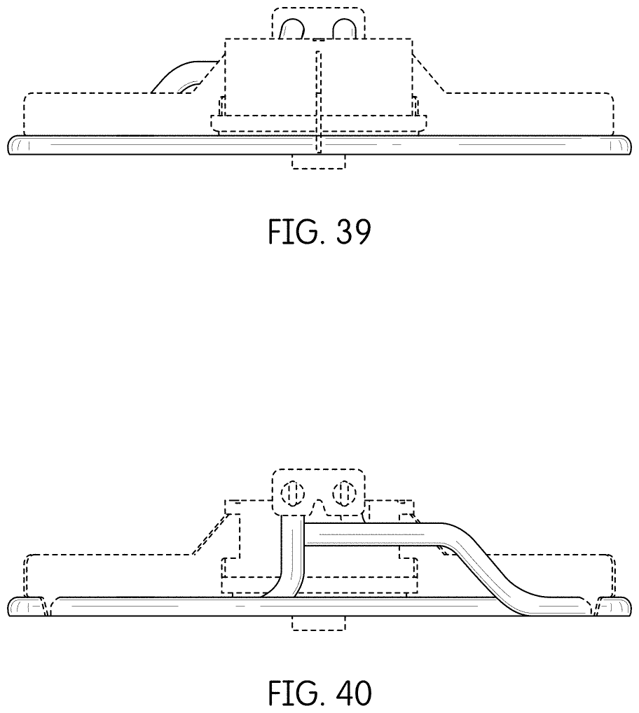

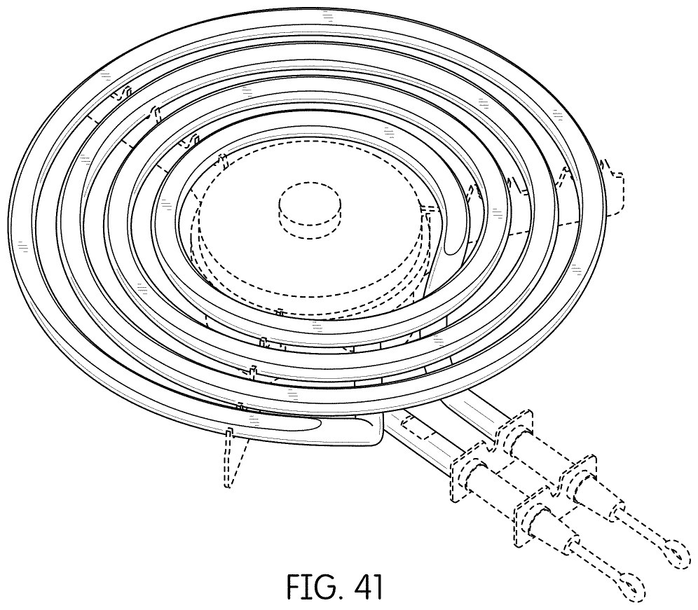

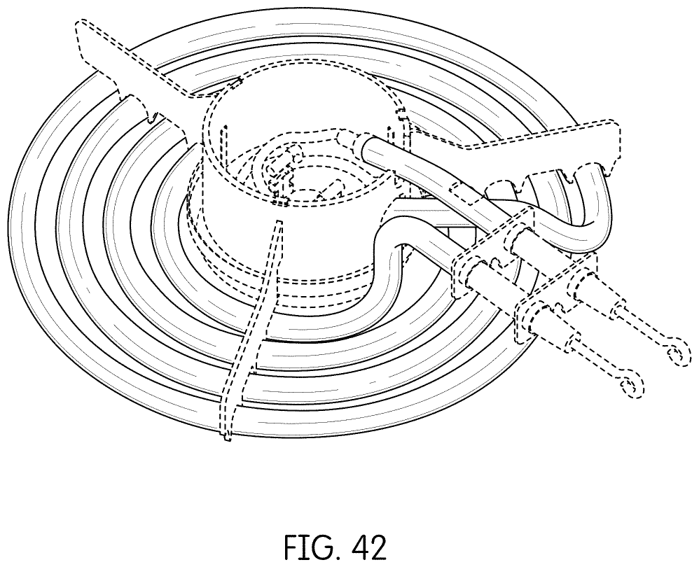

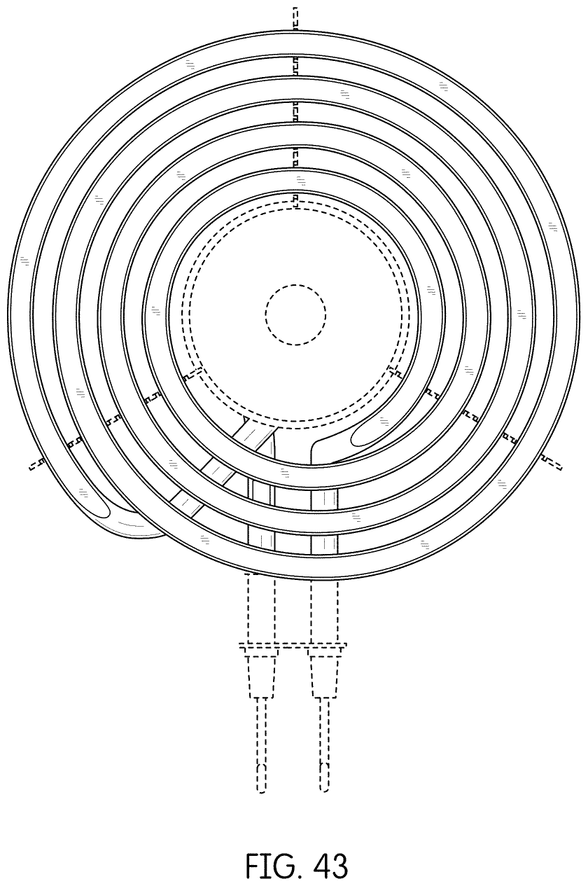

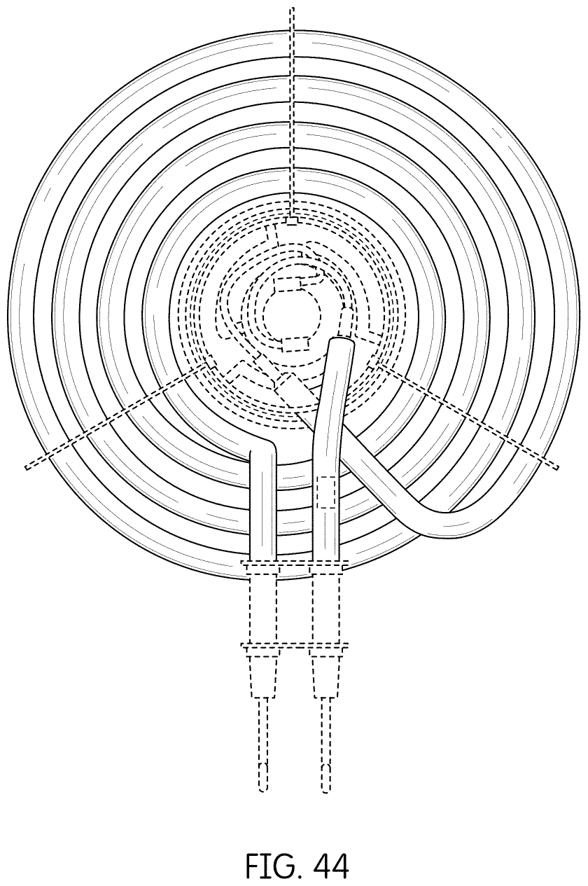

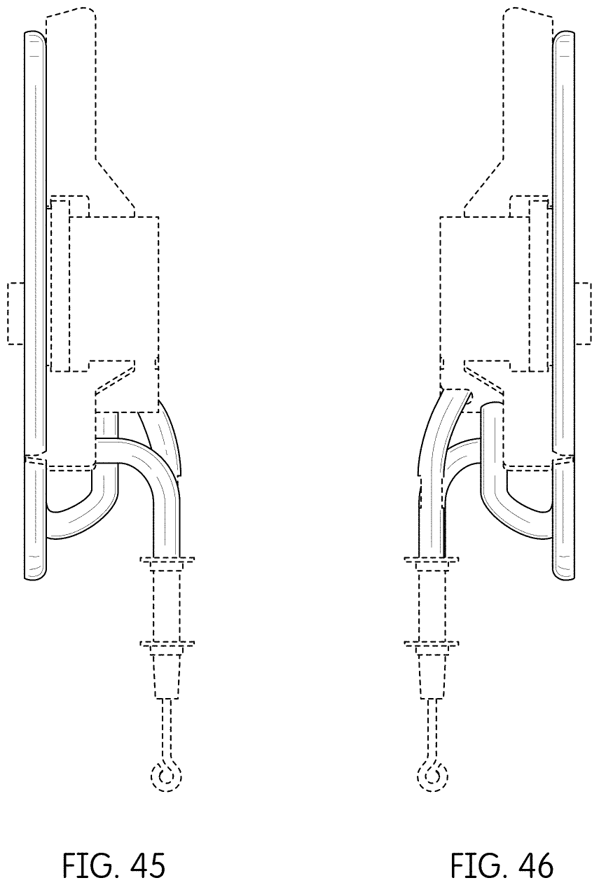

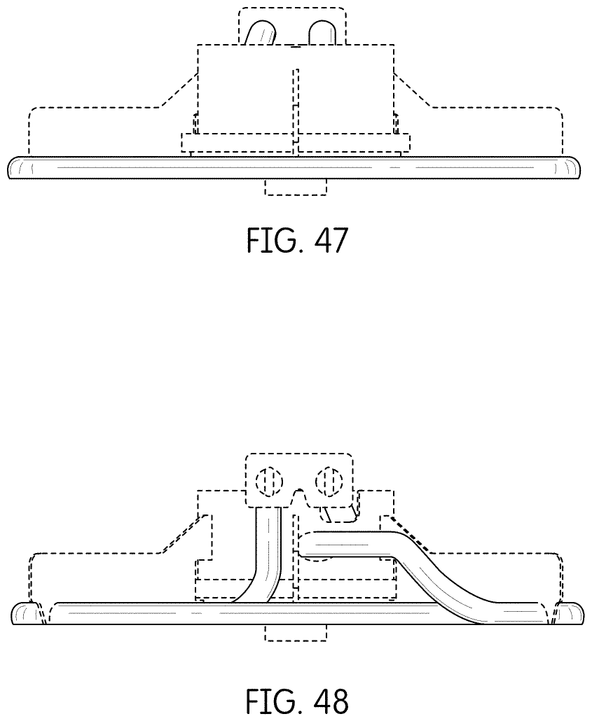

The dashed broken lines illustrate portions of the heater unit that form no part of the claimed design.

What is claimed is:

1. The ornamental design for a heater unit, as shown and described.
